(19) United States
(12) Patent Application Publication
(10) Pub. No.: US 2007/0198624 A1
(43) Pub. Date: Aug. 23, 2007

(54) Using a Document Model to Create and Maintain Dynamic Mathematic Representations Through Problem Spaces

(75) Inventors: Nikhil Nilakantan, Dallas, TX (US); Stephen Boatner Loe, Allen, TX (US); Gregory Thorne Springer, La Jolla, CA (US); Malgorzata Brothers, Plano, TX (US); Robert Charles Wellman Jenks, McKinney, TX (US); Charles Alan Donaldson, Rowlett, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/465,981

(22) Filed: Aug. 21, 2006

Related U.S. Application Data
(60) Provisional application No. 60/775,958, filed on Feb. 23, 2006.

(51) Int. Cl. G06F 7/38

(52) U.S. Cl. 708/490

(57) ABSTRACT

A device operable to maintain a document comprising a processor, a first problem space including a first variable having a first value, and a second problem space including a second variable having a second value, the first and second variables and the first and second values stored such that when the first variable is: the same as the second variable and the first value is different that the second value, the second value is maintained when the processor modifies the first value.

### CROSS-REFERENCE TO RELATED APPLICATIONS

This application claims priority to the provisional application, U.S. Pat. App. No. 60/775,958, entitled “Using a Document Model to Create and Maintain Dynamic Mathematic Representations Through Problem Spaces”, filed on Feb. 23, 2006, by Nikhil Nilakantan, et al. The above-referenced provisional application is incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to a system and method for organizing information in a handheld calculator or computer, and more particularly, but not by way of limitation, to a system and method for segregating and updating a plurality of variables in a document on a handheld calculator or computer.

### BACKGROUND OF THE INVENTION

Handheld calculators are well known in the art and have been in use for many years. Although many handheld calculators are limited to simple algebraic computations such as addition, subtraction, multiplication, and division, there are several commercially available handheld calculators that are able to perform higher level mathematical computations. For example, some handheld calculators allow a user to input a plurality of quadratic equations into the handheld calculator. The handheld calculator then graphs each of the equations on a coordinate plane and determines the intersection of the lines or curves created by the equations. The handheld calculator may also solve the quadratic equations algebraically. The same handheld calculator can also allow a user to enter a higher order and/or multi-variable equation into the handheld calculator and provide values for some of the variables. The handheld calculator can then solve for the remaining variables. Handheld calculators that perform these functions are manufactured by numerous companies including Texas Instruments.

The present invention provides a handheld calculator that can export its files to any type of computer or handheld calculator, can export the variables' values along with the formulas, records a history of modifications to the formulas, variables, and/or Values, and can define multiple values for a single variable. Such a handheld calculator would overcome the deficiencies in the existing products, thereby increasing the usefulness of the handheld calculator as an educational tool.

### SUMMARY OF THE INVENTION

In one aspect, the invention includes a device operable to maintain a document comprising a processor, a first problem space including a first variable having a first value, and a second problem space including a second variable having a second value, the first and second variables and the first and second values stored such that when the first variable is the same as the second variable and the first value is different than the second value, the second value is maintained when the processor modifies the first value.

In another aspect, the invention includes a handheld calculator comprising a processor, a memory electrically coupled to the processor, a display screen electrically coupled to the processor, and a document stored in the memory, the document being executed on the processor and displayed on the display screen in response to a user command, the document comprising: a first problem space including a first variable having a first value, and a second problem space including a second variable having a second value, the first and second variables and the first and second values stored such that when the first variable is the same as the second variable and the first value is different that the second value, the second value is maintained when the processor modifies the first value.

In a third aspect, the invention includes a method comprising creating a first variable having a first value; creating a second variable having a second value; and when the first variable is the same as the second variable, modifying the first value without modifying the second value.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates an embodiment of a document as viewed by a user;

FIG. 2 illustrates an embodiment of the structural organization of the document;

FIG. 3 illustrates an embodiment of the flow of logic used to modify a datastore;

FIG. 4 illustrates a block diagram of a mobile device operable for some of the various embodiments of the present disclosure; and

FIG. 5 is an exemplary general purpose device suitable for implementing the several embodiments of the disclosure.

### DETAILED DESCRIPTION OF THE PREFERRED EMBODIMENTS

While they are powerful computational tools, handheld calculators are limited in their usefulness as an educational tool. One aspect that limits existing handheld calculators is their lack of any cross-platform compatibility. For example, some handheld calculators are only able to export data to identical handheld calculators. Other handheld calculators are only able to transmit data to handheld calculators manufactured by the same company or using the same operating system. Still other handheld calculators are unable to download their files to a computer, such as a Windows or Unix-based personal computer or a Macintosh. Although some handheld calculators can export their equations and mathematical formulas in a document,: these handheld calculators are limited in that they are unable to export the variables' values along with the exported equations or formulas. The variables' values do not travel with the exported files because the handheld calculators' variable storage area is fixed within the handheld calculator, as opposed to residing within the exported document. Yet another limiting factor is that the handheld calculators do not adequately record the history of modifications. More specifically, when modifications are made to formulas, variables, and/or values, the handheld calculator overwrites the previous formulas, variables, and/or values with the new formulas, variables, and/or values, and the previous formulas, variables, and/or values are permanently lost. Finally, existing handheld calculators are limited in that they cannot define multiple values for the same variable.

The present application is related to U.S. patent application Ser. No. ______,entitled “Modeling Environment with Generally Accessible Variables for Dynamically Linked Mathematical Representation”, Nikhil Nilakantan et al. inventors, Attorney Docket No. (TI-62056)(1962-31001), U.S. patent application Ser. No. ______, entitled “Dynamic Data Flow and Data Linking”, Gregory Springer et al. inventors, Attorney Docket No. (TI-61634)(1962-30701). all of which are filed on even date herewith; and U.S. patent application Ser. No. 11/360,258, entitled “Tabular Environment that Supports Column Rules and Cell Rules”, Nikhil Nilakantan, Attorney Docket No. (TI-62017)(1962-30800) filed on Feb. 23, 2006, all of which are incorporated herein by reference for all purposes.

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their fill scope of equivalents.

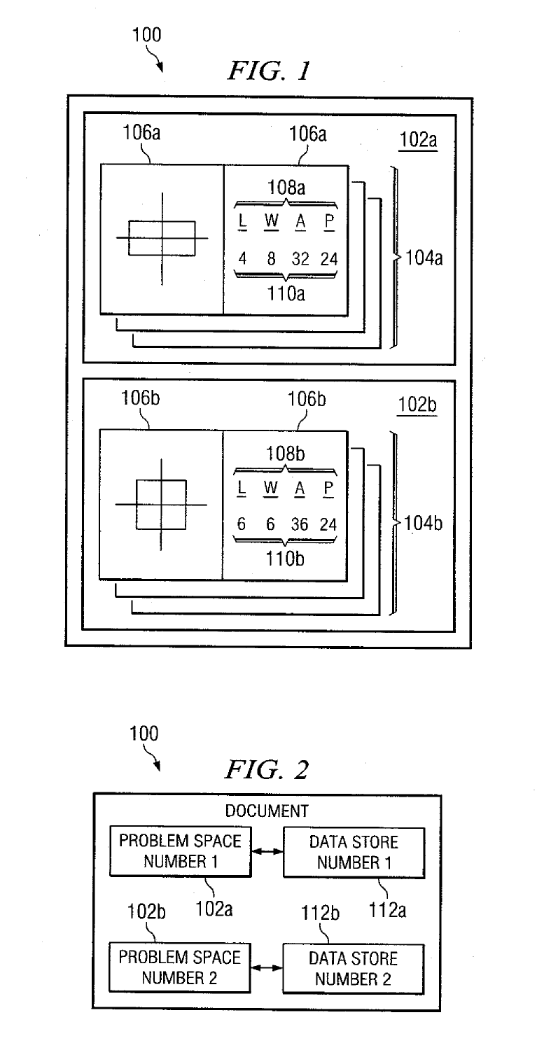

A document 100 is an electronic file that allows a user to solve a problem on a handheld calculator, a computer, or other such system (collectively referred to as “devices”). FIG. 1 is an illustration of one embodiment of the document 100 as viewed by a user. The document 100 is comprised of a plurality of problem spaces 102a and 102b, each of which is comprised of a plurality of cards 104a and 104b. Of course, persons of ordinary skill in the art will appreciate that the document 100 can be configured with any number of problem spaces. Although not illustrated in FIG. 1, each card 104a and 104b can contain a single environment 106a and 106b that allow the user to analyze and solve a problem depicted within the problem space 102a and 102b. However, it is also envisioned that each card 104a and 104b is comprised of a plurality of environments 106a and 106b as shown in FIG. 1. The environments 106a and 106b within each problem space 102a and 102b display a plurality of variables 108a and 108b and their associated values 110a and 110b in various formats, such as graphical and tabular. When a modification is made to one of the variables 108a and 108b or values 110a and 110b within any of the environments 106a and 106b, each environment 106a and 106b within the problem space 102a and 102b that displays the affected variable 108a and 108b or value 110 is updated such that they display the modified variable 108a and 108b or value 110a and 110b. However, the problem spaces 102a and 102b are independent of each other such that changes to variables 108a and 108b or values 110a and 110b in one problem space 102a and 102b do not affect the variables 108a and 108b or values 110a and 110b in the other problem spaces 102a and 102b.

The document 100 is associated with a datastore 112 that allows the variables 108a and 108b and values 110a and 110b in one problem space 102a and 102b to be modified without affecting the variables 108a and 108b and values 110a and 110b in the other problem spaces 102a and 102b. The relationship between the document 100, the datastores 112, and the problem spaces 102a and 102b is illustrated in FIG. 2. Each problem space: 102a and 102b is associated with a single datastore 112 where all of the variables 108a and 108b and values 110a and 110b contained in all of the environments 106a and 106b within the problem space 102a and 102b are stored. The one-to-one configuration of the problem spaces 102a and 102b and datastores 112 allows the variables 108a and 108b and values 110a and 110b within one problem space 102a and 102b to be modified without affecting the variables 108a and 108b and values 110a and 110b within the other problem spaces 102a and 102b, even when the two problem spaces 102a and 102b contain the same variables 108a and 108b and values 110a and 110b. Because previous handheld calculators could only define a single value for each variable, the problem spaces 102a and 102b allow the document 100 to perform functions that previously required a plurality of handheld calculators In addition, in contrast with the prior art devices that have a global variable storage space for the entire device, the inclusion of the datastore 112 within the document 100 allows the variables 108a and 108b and values 110a and 110b to be stored within the document 100 such that the variables 108a and 108b and values 110a and 110b are transferred with the document 100 when the document 100 is transferred to another device. Persons of ordinary skill in the art will appreciate that the plurality of datastores 112 can be configured as a single datastore that is partitioned or logically segregated such that it acts as the plurality of datastores 112 described herein.

The problem space 102a and 102b and datastore 112 allow a user to work though a plurality of problems on the cards 104a and 104b using the variables 108a and 108b and values 110a and 110b stored in the datastore 112 associated with the problem space 102a and 102b. Analogizing the document 100 to a textbook, the problem space 102a and 102b can be thought of as a group of problems that utilize a common set of variables and conditions, as is commonly found in word problems or textbook examples. The segregation of problem spaces 102a and 102b allows the variables and conditions for one group of problems to differ or be modified without affecting the variables and conditions for another group of problems. Returning to the analogy, the cards 104a and 104b may be thought of as the associated problems because the cards 104a and 104b focus on a specific individual problem within the group. The environments. 106a and 106b can then be thought of as the work areas used to solve each problem because they are the tools that the user uses to solve the individual problems.

There are several different types of environments that may be used within the cards, including a geometry grapher environment, a tabular environment such as a cell-based spreadsheet, a scratchpad environment, and a notepad environment. The geometry grapher environment can display the plot of algebraic equations on a plurality of coordinate axes. More specifically, the geometry grapher environment can access the variables 108 and values 110 stored in the datastore 112 and plot the variables 108 and values 110 on the coordinate axes. However, the geometry grapher environment is more than a mere plotter for data points and algebraic equations. The geometry grapher environment allows a user to draw geometric shapes on the coordinate axes. More specifically, the geometry grapher environment allows the user to draw a line, curve, or geometric shape on the coordinate axes and stores data related to the line, curve, or geometric shape as the variables 108 and values 110 in the datastore 112. The coordinate axes used by the geometry grapher environment include Cartesian coordinates, polar coordinates, cylindrical coordinates, spherical coordinates, and any other type of coordinates existing in one, two, or three dimensions. An example of the geometry grapher environment is shown in the left side of the cards in FIG. 1.

The tabular environment allows a user to define the variables 108 and values 110 within the problem space 102, define the relationship between the variables 108, and define the rules associated with the variables 108 and values 110. In one embodiment, the tabular environment comprises a plurality of cells that allow a user to define the variables 108 and values 110 used in the problem space 102. To define the variables 108 and values 110, the user enters the variable 108 in the header row of the tabular environment. The user may also enter one or a plurality of values 110 for each variable 108. The tabular environment stores each variable 108 and its value(s) 110 in an array in the datastore 112. The user may also use the tabular environment to define the relationship between two of the variables 108. For example, when referring to a rectangle having a width and a length, the user can define area as a variable and set it equal to the length multiplied by the width. The user can also define the perimeter as a variable and set it equal to the sum of twice the width plus twice the height. Alternatively, the user could define the length as well as the area or the perimeter, and have the tabular environment solve for the width. While it is envisioned that the document 100 can be pre-configured with rules for the variables, in an embodiment the user can also define rules associated with these variables. In defining the rules, the user is only constrained by the mathematical representations available on the device. These representations include geometric and algebraic forms. For example, the user can define area as a positive value, define the length and width as a positive value, or both using, for example, a menu or a dedicated input button. Persons of ordinary skill in the art will appreciate that other rules can be created to define the variables and equations. An example of the tabular environment is shown in the right side of the cards in FIG. 1.

The scratchpad environment allows a user to perform algebraic computations. In one embodiment the scratchpad environment acts as a traditional calculator in that the user can add, subtract, multiply, divide, and perform numerous other mathematical computations. However, the scratchpad environment is more functional than the traditional calculator because it is able to simultaneously display the computation entered by the user and the answer to the computation. The scratchpad environment also displays a history of the computations entered and answers obtained in the scratchpad environment. Thus, the user can view the last few computations conducted within the scratchpad environment. If desired, the user may also reference prior computations when entering additional computations in order to reduce the amount of data entry and save time.

The notepad environment allows a user to create a set of notes related to the other environments associated with the card. In one embodiment, the notes might include a word problem or the given conditions for a particular problem. For example, if a teacher gives a student a word problem, the notepad environment can contain the original word problem. The notepad environment may also contain user-created notes relating to the solution to the problem. Further, the notepad environment can interface with the datastore 112 such that the variables 108 and values 110 identified in the notepad environment can be transferred from the notepad environment to the datastore 112 so that the variables 108 and values 110 are associated and updated across all of the cards 104 and environments 106 within.

The problem spaces 102, cards 104, and environments 106 can be automatically created or can be created by the user. For example, when a user creates a new document 100, the new document 100 can be configured with one problem space 102 and one card 104. The user can then select which type of environments 106 will be used for that card 104. If desired, the user may create additional cards 104 within the problem space 102 using, for example, a drop down menu or a dedicated input button. Similarly, if the user wants to create a new problem space 102, the user may create additional problem spaces 102 within the document 100 using, for example, a drop down menu or a dedicated input button. The user may then transfer between the two or more problem spaces 102 as needed using known techniques. In one embodiment, when the user creates a new problem space 102, the document 100 copies the cards 104, the environments 106, the variables 108, and optionally the values 110 from the previous problem space 102 to the new problem space 102. Such a feature is useful when the first problem space 102 contains an example problem worked through by a teacher and the second problem space 102 contains a similar problem that the student must solve, but with different variables 108 and/or values 110 or for further exploration and learning by the student. If desired, the values 110 within the first problem space 102 may also be copied to the new problem space 102.

When solving a problem, it is sometimes necessary to modify at least one of the variables 108 or values 110. In one embodiment, the modification of the variables 108 and their values 110 originates from a single environment 106 in the problem space 102, but is displayed on a plurality of environments 106. When the variables 108 and values 110 originate from a single environment 106, the variables 108 and values 110 in the datastore 112 may be modified by modifying the variables 108 and values 110 within the originating environment 106. Returning to the rectangle example described above, the user can define the length and perimeter for a rectangle in the tabular environment and have the tabular environment calculate the width and area of the rectangle. In addition, the user can have the geometry grapher environment display a picture of the rectangle, as is shown in FIG. 1. In such an embodiment, the modifications to the variables 108 and values 110 originate in the tabular environment and are stored in the datastore 112. After the variables 108 and values 110 are stored in the datastore 112, the tabular environment and the geometry grapher environment access the variables 108 and values 110 in the datastore 112 and display the variables 108 and values 110 in the different environments 106 and/or formats.

Alternatively, the modifications to the variables 108 and values 110 may originate from a plurality of environments 106 within the problem space 102. Returning to the rectangle example, the length, width, area, and/or perimeter may be modified by changing their values in the tabular environment, and the modifications will be displayed in the adjacent geometry grapher environment. In addition, the length, width, area, and/or perimeter may be modified by using a cursor to grab a side or corner of the rectangle and dragging the side or corner of the rectangle to a new location. In such an instance, the modified length, width, area, and/or perimeter would be updated and displayed in the adjacent tabular environment, either by replacing the existing values or by adding a new row of values. Because any of the environments 106 may contain rules regarding the variables 108 and values 110, the potential for conflict among the rules is increased when a plurality of environments 106 may modify the rules. In one embodiment, the rules for all of the environments 106 are stored in the datastore 112 rather than the environments 106, and the datastore 112 resolves the conflicts wholly within the datastore 112. However, in another embodiment, the datastore 112 is provided with a conflict resolution algorithm that resolves any conflicts between the rules stored in the environments 106. For example, the width formula in the tabular environment might prevent the user from making certain modifications to the rectangle in the geometry grapher environment.

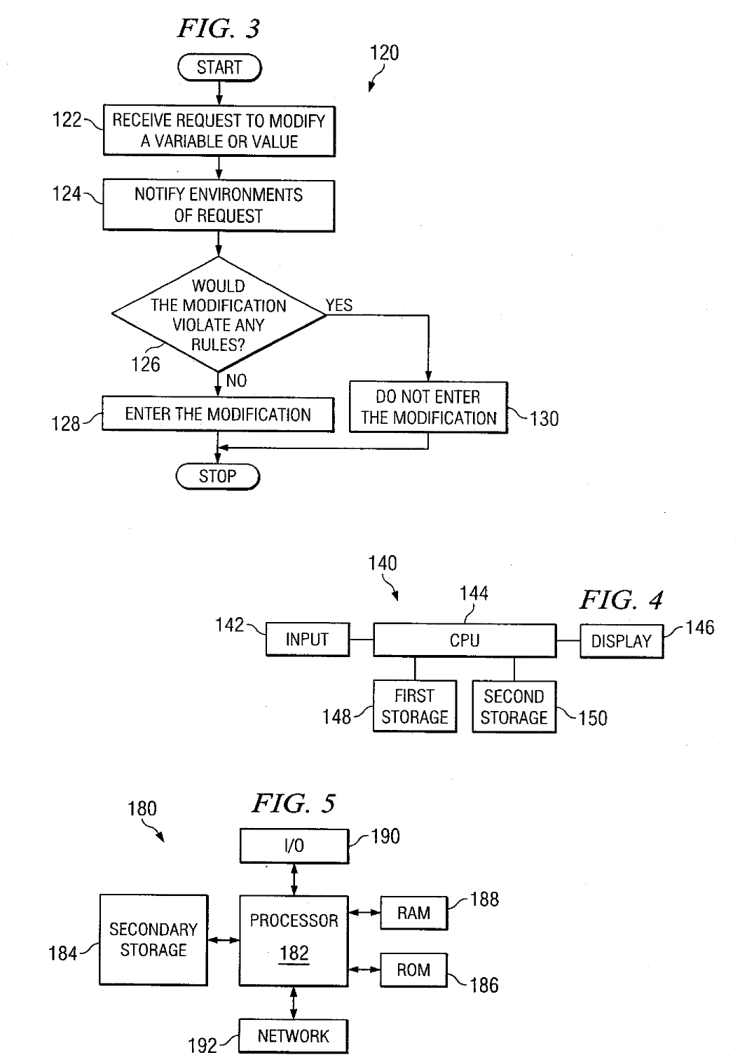

FIG. 3 is an illustration of the conflict resolution algorithm 120 used by the datastore to resolve conflicts in the rules. The conflict resolution algorithm starts when it receives a request to modify a variable or value (122). Typically, the user will modify the variable, one of its values, or a rule in the tabular environment and/or the geometry grapher environment, causing one or both of said environments to attempt to modify the variables or values within the datastore. However, it is also contemplated that the scratchpad or notepad environments may also request a modification of the variable or value.

Regardless of the origin of the request, after the datastore receives the request to modify a variable (122), the conflict resolution algorithm 120 notifies all of the environments within the problem space that there is a request to modify the variable (124). The notification of the request can be in any form, but in one embodiment, the notification is an electronic communication that identifies the requested modification in the variable and/or value. Once the notification is sent to the environments within the problem space, the individual environments determine whether the requested modification would violate any of their rules. The individual environments can respond in the affirmative or the negative as to whether the requested modification would violate their rules, or the environments can reply only if the requested modification violates their rules. In either case, the conflict resolution algorithm waits a period of time before proceeding.

After the conflict resolution algorithm 120 notifies all of the environments within the problem space that there is a request to modify the variable (124), the conflict resolution algorithm 120 determines whether the requested modification would violate any of the rules in any of the environments (126). Typically, the determination of whether the requested modification would violate any of the rules in any of the environments involves checking the notification responses from the environments to see if any of the environments indicated that the requested modification would violate any of their rules. If the conflict resolution algorithm 120 determines that the requested modification does not violate any of the rules in any of the environments, then the conflict resolution algorithm 120 enters the modification in the datastore (128) and ends. The conflict resolution algorithm 120 may optionally notify the environments when the requested modification occurs. If the conflict resolution algorithm 120 determines that the requested modification violates at least one of the rules in at least one of the environments, then the conflict resolution algorithm 120 does not enter the modification in the datastore (130) and ends. The conflict resolution algorithm 120 may then optionally notify the environments that the requested modification did not occur and/or explain to the user why the requested modification did not occur. Of course, persons of ordinary skill in the art will appreciate that the conflict resolution algorithm described herein can be modified if the user creates a hierarchical priority for the cards and environments described herein. Should the user create the hierarchical priority, modifications to the rules, variables, or values in one environment would be preferred over modifications to the rules, variables, or values in another environment.

After the variables 108 and/or values 110 in the datastore 112 have been modified, the environments 106 within the problem space 102 access the variables 108 and values 110 within the datastore 112 and update their displays. Generally, the display seen by the user is created by accessing the variables 108 and values 110 in the datastore 112. Generally, the individual environments 106 include software pointers that indicate the location of the variables 108 and values 110 stored in the datastore 112. As such, when a variable 108 or value 110 in the datastore 112 is modified, the information displayed in each of the environments 106 in the problem space 102 is also modified in a process referred to as dynamic updating. Dynamic updating may be defined as simultaneously updating the displays of all of the environments within a problem space with the modification of a variable or value from the datastore.

In addition to dynamic updating, the present document configuration has a number of additional advantages. For example, because the datastore 112 exists within the document 100 as opposed to within a central memory in the device, the document 100 is transferable between a plurality of different platforms, such as a Windows or Unix-based personal computer, a Macintosh, or a handheld calculator. The cross-platform transferability of the document 100 allows the document 100 to be uploaded, downloaded, emailed, or otherwise transported from one device to another. In another embodiment, the document 100 can be located on a server and accessed by a plurality of users. While such an embodiment allows a plurality of users to modify the variables 108 and values 110 in the datastore 112, it also requires electronic communication paths between the users' devices and the server storing the document 100 and optionally a user conflict resolution algorithm. Of course, persons of ordinary skill in the art will appreciate that the document 100 described herein has other advantages not specifically discussed herein.

One example of when the problem spaces described herein are useful as an educational tool is in capturing the progression of a problem's solution. More specifically, a user may solve a problem and create a new problem space for each step of the problem. Using the simple equation “y =2x−4” in which the user wants to rearrange the equation to solve for x and then determine the value of x when y=0, the user would first input the original equation “y=2x−4” into the first problem space. Next, the user would add four to both sides of the equation to generate the equation “y+4=2x”, and save is equation in the second problem space. Then the user would divide both sides of the equation by two to generate the equation “y/2+2=x”, and save this equation in a third problem space. In addition, the user would specify that y is equal to zero and enter zero into the equation for y to generate the equation “0/2+2=x”, and save this equation in a fourth problem space. Finally, the user can solve the algebraic expression to generate the equation “x=2” and save this equation in a fifth problem space. By saving each step of the problem's solution in a separate problem space, a teacher is subsequently able to follow the student's thought process as he solves the problem and is also able to identify the precise location of an error if the problem's solution is erroneous. Identification of the precise location of the error in the student's thought process allows the teacher to better educate the student. Furthermore, because each problem space is associated with its own datastore, when the student solves a second problem, such as “y=x+8” when y=2, the student can save the solution steps to this problem in another set of problem spaces while preserving the solution to the previous problem.

Another example of when the problem spaces described herein is in comparing theoretical or expected results with experimental or actual results. For example, suppose that a user has a container of known volume that contains a known amount of a gas. In a first problem space, the user can use the ideal gas law (PV=nRT; where P is the pressure, V is the volume, n is the amount of gas, R is a constant, and T is the temperature) to determine the expected pressure within the container for several temperature values. More specifically, the student can solve the ideal gas law for pressure, input several temperature values and calculate the theoretical pressure. The user can then create a second problem space in which the equations, variables, and values are the same as the first problem space, with the exception that the temperature and pressure values have been deleted. The second problem space can be used for collecting experimental data. The user can then measure the temperature of the container using a temperature measuring device such as a thermocouple, measure the pressure in the container using a pressure measuring device such as a pressure gauge, and input the temperature and pressure values into the second problem space as the experimental results. Alternatively, the temperature and pressure values could be collected though one of the device's input/output ports and automatically entered into the second problem space. The theoretical pressure and the experimental pressure can then be compared to determine if the gas acts as ideal gas at various temperatures. Moreover, because the variables and values are contained within the document, the user can transmit the theoretical and experimental results to a teacher for review and evaluation. The document transmitted to the teacher would not only contain the theoretical and experimental calculations, but would also contain the theoretical data used and the experimental data collected during the experiment.

Although handheld calculators contain many of the same components as computers, handheld calculators can be distinguished from computers in many ways. First, handheld calculators, unlike computers, do not typically contain hard drives or disk drives. Second, handheld calculators can be distinguished from computers in that handheld calculators contain a plurality of user input buttons dedicated to mathematical functions. Third, handheld calculators can be distinguished from computers in that handheld calculators contain an operating system that typically can only load and execute a single type of application or file, whereas computers can load an execute a plurality of different types of files. Persons of ordinary skill in the art are aware of other differences between handheld calculators and computers.

All or portions of the system described above may be implemented on any handheld mobile device 140 such as is well known to those skilled in the art. An exemplary handheld mobile device 140 for implementing one or more embodiments disclosed herein is illustrated in FIG. 4. The handheld mobile device 140 includes a processor 144 (which may be referred to as a central processor unit or CPU) that is coupled to a first storage area 148, a second storage area 150, an input device 142 such as a keypad, and an output device such as a display screen 146.

The processor 144 may be implemented as one or more CPU chips and may execute instructions, codes, computer programs, or scripts that it accesses from the first storage area 148 or the second storage area 150. The first storage area 148 might be a non-volatile memory such as flash memory. Handheld mobile device 140 data would typically be installed in the first storage area 148. The second storage area 150 might be firmware or a similar type of memory. The device's operating system would typically be installed in the second storage area 150.

When implemented on a computer, the system described above may be implemented on any device with sufficient processing power, memory resources, and network throughput capability to handle the necessary workload placed upon it. FIG. 5 illustrates a typical, general-purpose device suitable for implementing one or more embodiments disclosed herein. The device 180 includes a processor 182 (which may be referred to as a central processor unit or CPU) that is in communication with memory devices including secondary storage 184, read only memory (ROM) 186, random access memory (RAM) 188, input/output (I/O) 190 devices, and network connectivity devices 192. The processor may be implemented as one or more CPU chips.

The secondary storage 184 is typically comprised of one or more disk drives or tape drives in the case of a computer, or solid state memory in the case of a handheld calculator, and is used for non-volatile storage of data and as an over-flow data storage device if RAM 188 is not large enough to hold all working data. Secondary storage 184 may be used to store programs which are loaded into RAM 188 when such programs are selected for execution. The ROM 186 is used to store instructions and perhaps data which are read during program execution. ROM 186 is a non-volatile memory device which typically has a small memory capacity relative to the larger memory capacity of secondary storage. The RAM 188 is used to store volatile data and perhaps to store instructions. Access to both ROM 186 and RAM 188 is typically faster than to secondary storage 184.

I/O 190 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 192 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 192 devices may enable the processor 182 to communicate with an Internet or one or more intranets. With such a network connection, it is contemplated that the processor 182 might receive information from the network, or might output information to the network in the course of performing the above-described method steps. Such information, which is often represented as a sequence of instructions to be executed using processor 182, may be received from and outputted to the network, for example, in the form of a computer data signal embodied in a carrier wave

Such information, which may include data or instructions to be executed using processor 182 for example, may be received from and outputted to the network, for example, in the form of a computer data baseband signal or signal embodied in a carrier wave. The baseband signal or signal embodied in the carrier wave generated by the network connectivity 192 devices may propagate in or on the surface of electrical conductors, in coaxial cables, in waveguides, in optical media, for example optical fiber, or in the air or flee space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 182 executes instructions, codes, computer programs, scripts which it accesses from hard disk, floppy disk, optical disk (these various disk based systems may all be considered secondary storage 184), ROM 186, RAM 188, or the network connectivity devices 192.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A device operable to maintain a document comprising:
a processor;
a first problem space including a first variable having a first value; and
a second problem space including a second variable having a second value, the first and second variables and the first and second values stored such that when the first variable is the same as the second variable and the first value is different that the second value, the second value is maintained when the processor modifies the first value.

2. The device of claim 1 wherein the first and second variables have the same name.

3. The device of claim 1 wherein the first problem space hither comprises a plurality of environments that display the first variable and the first value.

4. The device of claim 3 wherein one of the plurality of environments modifies one of the first variable and the first value, wherein the modification to one of the first variable and the first value is displayed in all of the environments in the first problem space, and wherein one of the first variable and the first value are displayed on one of the environments.

5. The device of claim 3 wherein a plurality of the environments modify one of the first variable and the first value, and wherein the modification to one of the first variable and the first value is displayed in all of the environments in the first problem space.

6. The device of claim 3 wherein the problem space further comprises: a rule that defines one of the first variable and the first value.

7. The device of claim 3 wherein the problem space further comprises:
a plurality of rules that define one of the first variable and the first value; and
a conflict resolution algorithm for resolving conflicts between the rules.

8. The device of claim 1 wherein the device is one of a system operable with a Windows-based operating system, a Unix-based operating system, a Mac-based operating system, and a handheld calculator operating system.

9. A handheld calculator comprising:
a processor;
a memory electrically coupled to the processor;
a display screen electrically coupled to the processor; and
a document stored in the memory, the document being executed on the processor and displayed on the display screen in response to a user command, the document comprising:
a first problem space including a first variable having a first value; and
a second problem space including a second variable having a second value, the first and second variables and the first and second values stored such that when the first variable is the same as the second variable and the first value is different that the second value, the second value is maintained when the processor modifies the first value.

10. The calculator of claim 9 wherein the first problem space is independent of the second problem space.

11. The calculator of claim 10 wherein modification of the first variable does not affect the second variable.

12. The calculator of claim 10:
wherein the first variable has a first value and the second variable has a second value; and
wherein modification of the first value does not affect the second value.

13. The calculator of claim 9 wherein the first problem space further comprises a plurality of environments that display the first variable and the first value.

14. The calculator of claim 13 wherein a plurality of the environments modify one of the first variable and the first value) and wherein the modification to the first variable or first value is displayed in all of the environments in the first problem space.

15. A method comprising:
creating a first variable having a first value;
creating a second variable having a second value; and
when the first variable is the same as the second variable, modifying the first value without modifying the second value.

16. The method of claim 15 further comprising: receiving a user input to modify the first value.

17. The method of claim 15 further comprising:
associating a first problem space with the first datastore; and
associating a second problem space with the second datastore;
wherein the modification of the first value is displayed in the first problem space but is not displayed in the second problem space.

18. The method of claim 15 further comprising:
associating a first environment with the first problem space;
associating a second environment with the first problem space; and
displaying the modification of the first value in the first environment and the second environment.

19. The method of claim 18 wherein the first environment and the second environment dynamically update in response o the modification of the first value.

20. The method of claim 18 wherein the first environment and the second environment are selected from the group consisting of: a tabular environment, a geometry grapher environment, a scratchpad environment, and a notepad environment.
